(19) United States
(12) Patent Application Publication
(10) Pub. No.: US 2014/0071994 A1
(43) Pub. Date: Mar. 13, 2014

(54) Method and Systems for Full Duplex Communication Using a Single Channel

(71) Applicants: Steven Sharp, Largo, FL (US); Katheryn Glasscock, Clearwater, FL (US)

(72) Inventors: Steven Sharp, Largo, FL (US); Katheryn Glasscock, Clearwater, FL (US)

(21) Appl. No.: 13/607,788

(22) Filed: Sep. 9, 2012

(51) Int. Cl. H04L 1/16

(52) U.S. Cl. CPC H04L 1/1685
USPC 370/445

(57) ABSTRACT

Current communication systems must not allow signal collision in order to avoid corruption of information. Proposed is a new shared channel system that will allow for more utilization of bandwidth by allowing two signals to collide. This shared channel technique extracts information from the collision of the two signals sent by two different transmitters. The signal of interest is extracted from the collision by undoing the effect of the channel and by removing the known signal from the resultant. This technique makes it possible for full duplex communication with a single communication channel or medium.

### CROSS-REFERENCE TO RELATED APPLICATIONS

NA

### FEDERALLY SPONSORED RESEARCH

NA

### SEQUENCE LISTING OF PROGRAM

NA

### BACKGROUND

1. Field Class 276 Duplexing

This invention generally relates to Telecommunications, specifically to duplex communication over a single communication channel or medium.

2. Prior Art

Previous techniques for two way communication over a single channel include Time division duplexing and frequency duplexing. Time division duplexing, like cell phones and walkie-talkies, use one channel to transmit and receive. Two-way communication is achieved through time sharing of the single channel. The drawback to this is that only one user can transmit at a time.

Frequency Duplex communication is achieved through subdividing a channel into different frequencies for the transmitter and receiver. One or more Frequency divided channels are used for transmission of signals and the other frequency channel(s) are used for reception signals. The draw back with this technique is that the channels have a smaller bandwidth than the original non-frequency divided channel.

The invention proposed will use a single channel to allow two way simultaneous communication. This shared channel Full duplex combines the benefits of using a single channel, like half duplex, and simultaneous two way communication, like full duplexing.

### SUMMARY

The following presents a simplified summary of the Method and systems disclosure in order to provide a basic understanding to the reader. This summary is not an extensive overview of the disclosure and it does not identify key/critical elements of the invention or delineate the scope of the invention. Its only purpose is to present some concepts disclosed herein in a simplified form as a prelude to the more detailed description that is presented later.

We propose a method and systems by which two users utilize the same channel to send and receive data at the same time. This shared channel method utilizes the principal of superposition to reconstruct the other's signal. The signal is sent by both users on the same medium at the same time. The collision of the signals results in a new signal. The collided signal is propagated in either direction and is received by both users. The collided signal, which has the information of both signals, is subtracted by the original sent signal that has been modified. The modification is intended to duplicate the effects of the channel on the sent signal. The channel must be well known to be able to duplicate the effects. Also timing of the sent signals must be synchronized to ensure that the signals will collided at a known location and the appropriated effects can be applied in the modification of the signal to be removed from the collided signal. The resultant is that data that was sent by the other user, thus two way communications over a single channel is achieved.

In accordance with one embodiment, Op-amps are used to isolate the medium from the transmitter and the reception of the collided signal. The signal to be sent is sent through a non-inverting op-amp to the medium, and to a channel simulation circuit then to the inverting side of the receiving op-amp. The channel simulation circuit mimics the affects that the medium or channel has on the signal. These effects include, delay, phase shift, and attenuation. The medium is also connected to the non-inverting input of the receiving op-amp. The collided signal is received and the user's transmitted data, after the channel simulation circuit, is the removed from the collided signal; resulting in a usable signal from the other user.

In accordance with another embodiment light is used as a communications encoding scheme, such as fiber optic communication. Light at a particular wave length is encoded and sent to another user across a fiber optic cable. The other user also sends a signal light encoded signal. As above each user has a channel mimicking device that simulated the effects of a single signal through the medium or channel. The encoded light is also passed through this device. The resultant collision of light on the medium is then passed through a device that combines the light from the simulated channel in a destructive fashion as to remove that part from the collided light signal.

### DRAWINGS

FIGS. 1, 2 and 3

### REFERENCE NUMERALS

10 sending signal input
11 isolation Op-amp
12 Channel simulation block diagram, mimics the effects the channel. These effects include delay, phase shift and attenuation.
13 receiving Op-amp
14 reconstructed signal
15 channel or medium where signals collide

FIG. 2 shows a transmission and receiving block diagram for both users
20 sent signal from user A
21 isolation Op-amp for user A
22 Channel mimicking circuitry
23 receiving Op-amp for user A
24 reconstructed signal from user B
25 channel or medium where signals collide
26 sent signal from user B
27 isolation Op-amp for user B
28 receiving Op-amp for user B
29 reconstructed signal from user B

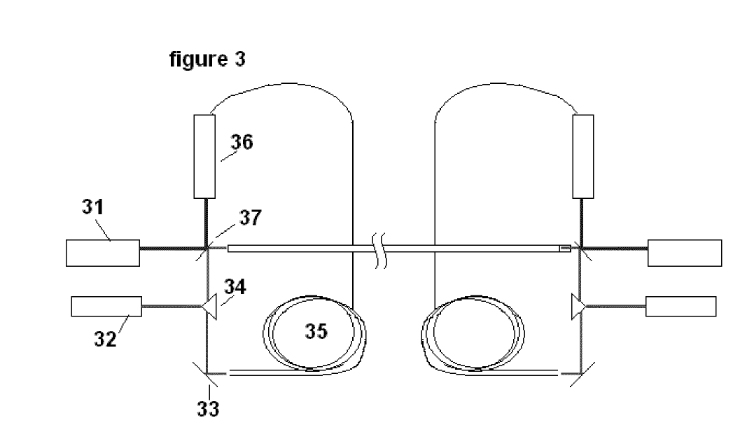

FIG. 3 show a fiber optic duplex over a single medium/communication channel
31 received signal from the sender
32 encoded laser producer
33 mirror
34 prism
35 channel simulation, length of fiber optic
36 light level inverting device
37 partially silvered mirror

### DETAILED DESCRIPTION

### First Embodiment

### FIGS.

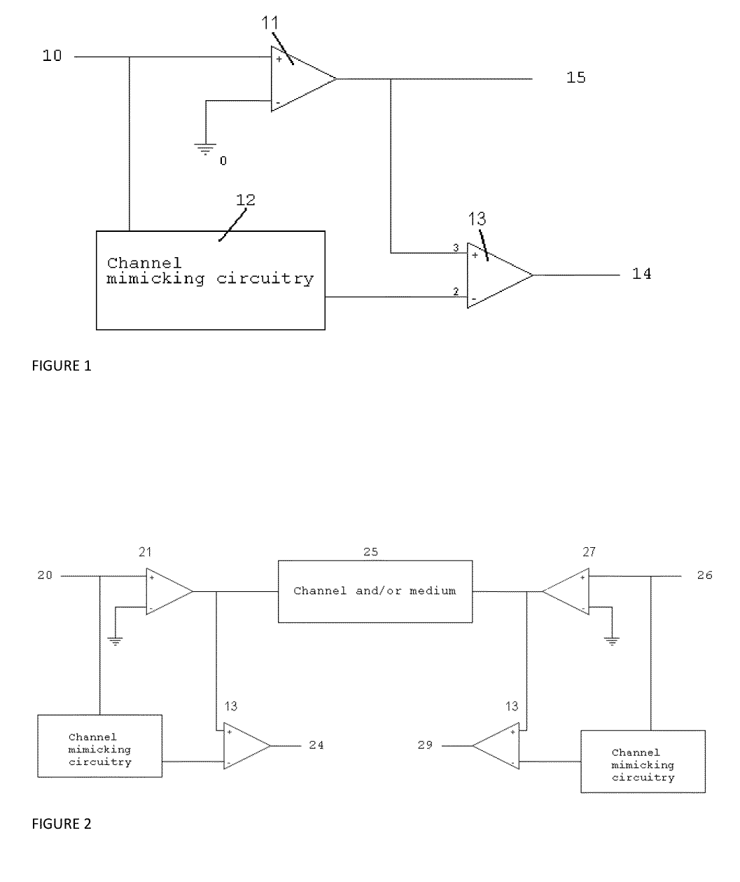

One embodiment of the technique is illustrated in FIG. 1 (showing a single user circuit) and FIG. 2 (showing both user circuits). The simulation channel circuitry is not depicted since it can take on many forms to fulfill the necessary function. And example circuit can be seen in FIG. 3. This simulation circuit has a phase shift, attenuation and a delay. The delay is formed by the gate delay inherent to the physical properties of the TTL gate. By using 4 NAND gates the approximate delay is 74 ns. The delay represents the delay that would occur if an electromagnetic wave traveled through a length of wire approximately 22 meters.

The Op-amps labeled figure references 11, 21 and 27 are used to isolate the medium from the transmitted signal and the reception of the collided signal. The signal to be sent is sent through a non-inverting op-amp(s), figure references 11, 21 and 27 to the transmission line and to a channel simulation circuit, figure references 12 and 22, creating a cancellation signal. The cancelation signal is an estimation of the effects that the channel being transmitted on has on just the signal that the transmitter is sending.

The cancelation signal is applied to the inverting side of the receiving op-amp figure references 13, 23 and 28. The channel simulation circuit mimics the affects that the transmission medium or channel has on the transmitting signal figure references 10 and 20. These affects include delay, phase shift, and attenuation. The medium is also connected to the non-inverting input of the receiving op-amp FIGS. 13, 23 and 28. The collided signal is received the cancelation signal is applied, resulting in a residual signal. The resulting residual is a signal from the other user and depending on the noise level on the channel, some residual noise. Further processing can be used such as hard limiting and filtering to better recover the received signal.

### Operation

### Alternative Embodiment

### FIGS. 1 and 2.

The operation of the first embodiment is straight forward. A digital signal, with voltages between 5 and 0 volts, is applied to the non-inverting port of op-amp. The output from the op amp is then sent over the medium. In this example, a cable is being used. The transmitting signal is also routed through a delay and attenuation simulations channel. This simulation channel is made of NAND gates and resistors and a inductor. These devices mimic the delay, attenuation and phase shift that is to be expected to be found in the channel. These values are specifically found for a particular channel since these values are unique to the medium and length of medium. The transmission cable is also connected to the receiving portion of the circuitry by another op-amp. This op-amp take the signal that is received and removes the sent signal.

### Description

### Alternative Embodiment

### FIG. 3

Fiber optic communication forms the backbone of the backhaul infrastructure of the internet. Most cable suns are implemented in a double ring for redundancy purpose and traffic balancing. A single fiber-optic cable sends millions of bits per minute in a single direction. The duplexing technique can also be used in a fiber optic channel. This is done in a similar fashion as the first embodiment. The signal is split and routed in two directions. The first path is across to the receiving side. The second is routed through a simulation network that mimics the effects that the fiber optic cable has on the signal. These effects include delay, Doppler shift, and attenuation. This signal from the second path is also inverted.

The signal sent over the fiber optic channel collides, at a known location with another signal. The result, traveling in both directions, is received. The received signal is combined with the modified send signal from the second path. The result from the mixing of the collided signal and the modified sent signal will be the signal sent from the other transmitter.

### Operation

### Alternative Embodiment

### FIG. 3

The operation of a fiber optic duplexing over a single channel is fairly straight forward. A laser beam is encoded by accepted means with information FIG. 3. A prism, or prism like device, is used to split the light encoded signal though the two paths. The first path travels through a partially silvered mirror. The second path leads to a channel mimicking network. In this embodiment it is a coil of a similar length and the exact type of medium used between the two transceivers. This will mimic the effects the channel has on the encoded laser light.

The partially silvered mirror allows for the operator to gain access to the collided signal as well as providing a path for the transmission of the information to the other side of the channel. The collided signal is received from the other side of the partially silvered mirror.

### Conclusion, Ramifications, and Scope

Accordingly the reader will see that, according to the embodiments of the invention, I have provided adequate information so that someone with a background in electronics or optics could replicate the process that I have described. That a shared channel duplexing does work to the better utilize the bandwidth communication channels.

While the above description contains many specificities, these should not be construed as limitations on the scope of any embodiment, but as exemplifications of various embodiments thereof. Many ramifications are possible within the teaching of the various embodiments. For example, the first embodiment comprises of op-amps, which can be replaced with transistors circuitry. Another example is that the medium that the signal is sent over is not specified, this medium could be RF, or transmission line.

Thus the scope should be determined by the appended claims and their legal equivalents, and not by the examples given.

We claim:

1. A method utilizing a shared communication medium with a transceiver device having a transmitter circuit and a receiver circuit, comprising: receiving signal on the shared communication medium at the receiver circuit; responsive to receiving the signal wherein: if a further data is not waiting to be sent then transmitting a busy tone, and if a further data is waiting to be sent , send signal to the recipient for the further data signal and initiating transmission of an output signal comprising the further data signal from the transmitter circuit on the shared communication medium; concurrently with the transmission of the output signal from the transmitter circuit on the shared communication medium, receiving an impaired data signal at the receiver circuit on the shared communication medium, wherein the impaired data signal comprises a data packet payload and interference from the output signal; deriving a cancellation signal from the output signal; combining the cancellation signal with the impaired data signal to remove the output signal and recover the data packet payload; and determining if the data packet payload is still being received and in the case that the data packet payload is still being received, completing the transmission of the further data packet and then transmitting a predefined sequence of symbols, and in the case that the data packet payload has been fully received, transmitting an acknowledgement packet.

2. A method as claimed in claim 1, wherein the output signal comprises a predefined sequence of symbols.

3. A method as claimed in claim 1, wherein the output signal comprises an unmodulated carrier.

4. A method as claimed in claim 1, wherein the step of combining the cancellation signal with the impaired data signal comprises subtracting the cancellation signal from the collided data signal.

5. A method as claimed in claim 1, wherein the step of deriving a cancellation signal comprises applying a phase shift to the sent signal.

6. A method as claimed in claim 1, wherein the step of deriving a cancellation signal comprises applying attenuation to the sent signal.

7. A method as claimed in claim 1, wherein the step of deriving a cancellation signal comprises applying a time delay to the sent signal.

8. A method as claimed in claim 1, wherein the shared communication medium is a radio channel.

9. A radio transceiver comprising: a receiver circuit; a transmitter circuit; and a processor connected to the receiver circuit and the transmitter circuit, wherein the processor is arranged to calculate a transmit window size, wherein the transmit window size is decreased when the transceiver was unable to transmit in a previous time period, initiate transmission of a data packet to a recipient from the transmitter circuit on a predetermined radio channel at a time instance within the transmit window, concurrently with the transmission of the signal from the transmitter circuit on the predetermined radio channel, listen on the predetermined radio channel for a response originating from the recipient by deriving a cancellation signal from the transmitted signal and combining the cancellation signal with a received signal at the receiver circuit to remove interference caused by the collision of the transmitted signal and leave a residual signal, and determine whether the residual signal comprises the response originating from the recipient of the signal and in the case that the residual signal does comprise the response originating from the recipient, completing the transmission of the signal and then transmitting a predefined sequence of symbols until an acknowledgement signal is received from the recipient.

10. A radio transceiver according to claim 9, further comprising a receive antenna connected to the receiver circuit, and a transmit antenna connected to the transmit circuit.

11. A radio transceiver according to claim 9, wherein the radio transceiver is a carrier-sense multiple access radio transceiver.

12. A method of accessing a shared communication medium with a transceiver device having a transmitter circuit and a receiver circuit, comprising: initiating transmission of a signal to a recipient from the transmitter circuit on the shared communication medium; concurrently with the transmission of the signal from the transmitter circuit on the shared communication medium, listening on the shared communication medium for a response signal, originating from the recipient by deriving a cancellation signal from the transmitted signal and combining the cancellation signal with a received signal at the receiver circuit to remove interference caused by the transmitted signal and leave a residual signal from the recipient of the signal and in the case that the residual signal does comprise the signal from the recipient.

13. A method as claimed in claim 12, further comprising calculating a transmit window size, wherein the transmit window size is decreased when the transceiver was unable to transmit in a previous time period.

14. A method as claimed in claim 13, wherein the step of initiating transmission comprises initiating transmission of the carrier signal to the recipient from the transmitter circuit on the shared communication medium at a time instance within the transmit window.

15. A method as claimed in claim 14, wherein the time instance is randomly selected from within the transmit window.

16. A method as claimed in claim 12, wherein, in the case that the residual signal does not comprise the response originating from the recipient, ceasing the transmission of the signal and scheduling a re-transmission of the signal.

17. A method as claimed in claim 12, wherein the shared communication medium is a radio channel.

18. A method as claimed in claim 12, wherein the shared communication medium is light.

19. A method as claimed in claim 12, wherein the shared communication medium is sound.
